(19) United States
(12) Patent Application Publication
(10) Pub. No.: US 2009/0133342 A1
(43) Pub. Date: May 28, 2009

(54) Insulated Access Cover

(76) Inventor: Jerry Lee Copeland, Belmont, NC (US)

Correspondence Address: JERRY LEE COPELAND, 608 SOUTH FOREST LANE, BELMONT, NC, 28012, US

(21) Appl. No.: 12/275,569

(22) Filed: Nov. 21, 2008

Related U.S. Application Data
(60) Provisional application No. 60/989,822, filed on Nov. 22, 2007.

(51) Int. Cl. E06B 3/263; E04B 1/78; E04B 1/62

(52) U.S. Cl. 52/202; 52/404.1; 52/741.4

(57) ABSTRACT

To achieve the foregoing and other objects, the present invention, as embodied and broadly described herein, provides various embodiments of a scuttle hole (hatch) insulated cover with a magnetic air sealing system. The invention is also used to seal and insulate air vents, ventilation fans, exhaust fans, roof hatch openings, and service access panels.

### BACKGROUND OF THE INVENTION

### Field of the Invention

Concerning ceiling scuttle hole entrances into attics or as commonly referred to by the public as hatch access door in residential homes, most are not covered with any insulation and provide no effective sealing method to prevent heat loss or gain or infiltration/exfiltration from the conditioned living space.

Many general contractors remove a small section of sheetrock from the ceiling by cutting out the sheetrock opening and trimming the cut piece to fit loosely within the hole. The contractor installs trim around the hole, reinstalls the uninsulated sheetrock piece removed earlier in the hole, and paints the sheetrock to match the ceiling.

These attic access openings are installed for service and or storage in the unconditioned attic space. They are often located in a hallway or other areas of the home for access to store items or service electrical and mechanical equipment. Conventionally, unconditioned spaces are insulated from the remaining portion of the building in order to minimize heat transfer between the unconditioned and conditioned portion of the house. For example, it is common to have ample insulation in an unconditioned floor, with an R-value of 38 or higher, to reduce heat transfer from the unconditioned to the conditioned areas during the summer, as well as reduce heat transfer from the conditioned areas to the unconditioned areas during the winter. However, conventional insulation is difficult and impractical to install over a scuttle hole entrance door.

Many recommendations to seal these openings are recommended by individuals as well as the Department of Energy. There are complete replacement kits with a preformed plastic case and insulation available. However, these replacement units are a standard size and may not be used in many homes because of location and size. Other methods of insulating the hatch door recommended by the Department of Energy may be to glue Styrofoam to the back of the access panel and a gasket strip around the panel perimeter to help seal the unit. This is an acceptable method to help insulate the hatch panel but lacks the ability to seal the hatch access panel when the pressure between the unconditioned space and the conditioned space is excessive due to wind and changing pressures within the conditioned area due to bathroom exhaust fans, kitchen exhaust fans, dryer exhaust fans and unsealed Heating system ducts.

Accordingly, what is needed is an improved device for insulating and sealing the attic access panel between the conditioned space and unconditioned space. A better way is to install insulation material on the bottom of the panel with an advanced self-aligning magnetic sealing system to ensure an airtight seal when the attic access panel is closed. Additional conventional insulation may be applied on top of the access panel after installation of the magnetic sealing system. An alternate method may be to replace the entire panel with a rigid insulated panel composed of a plurality of layers to increase the R Value in conjunction with using an advanced self-sealing system.

### BRIEF SUMMARY OF THE INVENTION

To achieve the foregoing and other objects, the present invention, as embodied and broadly described herein, provides various embodiments of an insulated attic access cover for use in scuttle holes, attic fan openings such as a shutter, and crawl space access openings. The invention includes a magnetic sealing system and its components in various forms along with flexible insulation material with and without a radiant barrier, rigid foam insulation, semi-rigid insulation, or other commonly known insulation materials.

The invention typically uses a cut to fit insulation that can be flexible, semi rigid, or rigid to insulate an attic access panel and includes a magnetic sealing system to ensure an airtight seal around the attic access panel perimeter.

### BRIEF DESCRIPTION OF DRAWINGS

The above described and other features, aspects, and advantages of the present invention are better understood when the following detailed description of the invention is read with reference to the accompanying drawings, wherein:

FIG. 1 is a cut away side view of the invented insulated cover and sealing system shown installed on a typical scuttle hole panel.

FIG. 2 is a side view of the invented insulated cover and sealing system.

FIG. 3 is a view of the insulated cover magnetic sealing system components.

FIG. 4 is a side view of the invented insulated cover and sealing system installed on an access panel and the access opening trim.

FIG. 5 is a view of the ceiling attic access opening trim from the conditioned space side.

FIG. 6 is a view of the ceiling attic access opening trim from the unconditioned space side with the magnetic sealing system base installed on the trim.

FIG. 7 is a view of the attic access-opening panel from the unconditioned space side.

FIG. 8 is a view of the ceiling trim from the conditioned space side with the magnetic sealing system and insulation installed,

FIG. 9 is a perspective view of the attic access panel installed in the opening after attachment of the insulated cover and sealing system.

### SPECIFICATION

The present invention will now be described more fully hereinafter with reference to the accompanying drawings in which a representative embodiment of the invention is shown.

This invention may, however, be embodied in many different forms and shapes. The invention should not be considered as limited to the embodiments as set forth herein. These exemplary embodiments are provided so that this disclosure will be both thorough and complete, and will fully convey the scope of the invention to those skilled in the art.

In various embodiments of the present invention, an insulated cover for an attic access opening commonly referred to as a hatch or scuttle hole cover is described for reducing heat transfer between an unconditioned space and the conditioned portion of a building or house by magnetically sealing and insulating the access cover on the conditioned side.

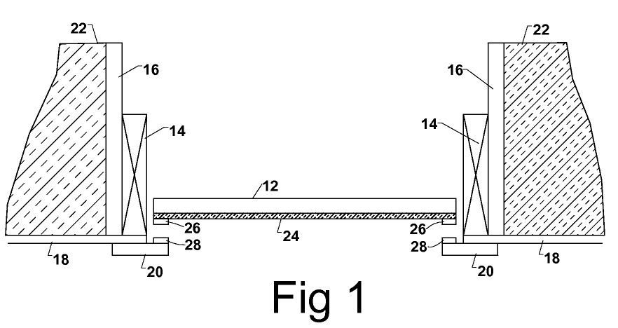

Referring to specifically FIG. 1, which shows a cutaway view of a typical attic access scuttle hole with ceiling sheetrock 18, ceiling opening trim 20, attic side insulation 22, insulation dams 16, ceiling rafters 14, which frame the opening, access panel 12 and a flexible insulated cover 24 with a magnetic sealing system consisting of separate pieces 26 and 28.

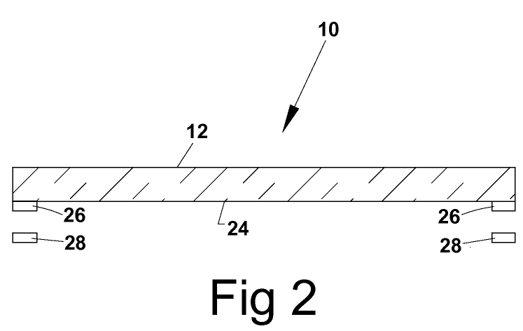

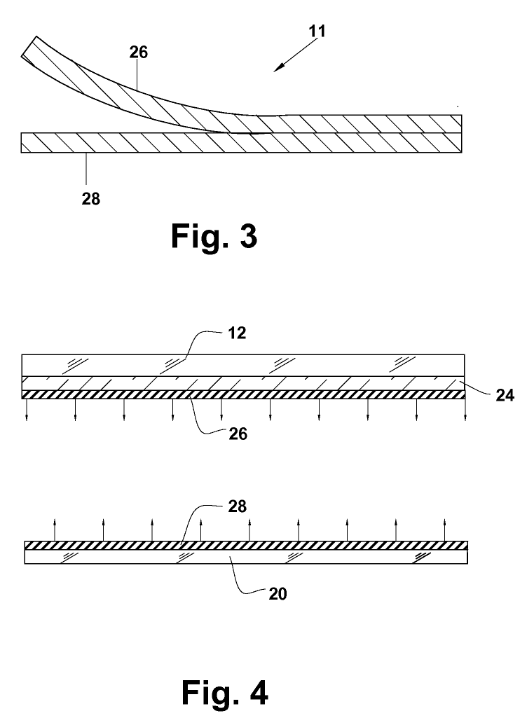

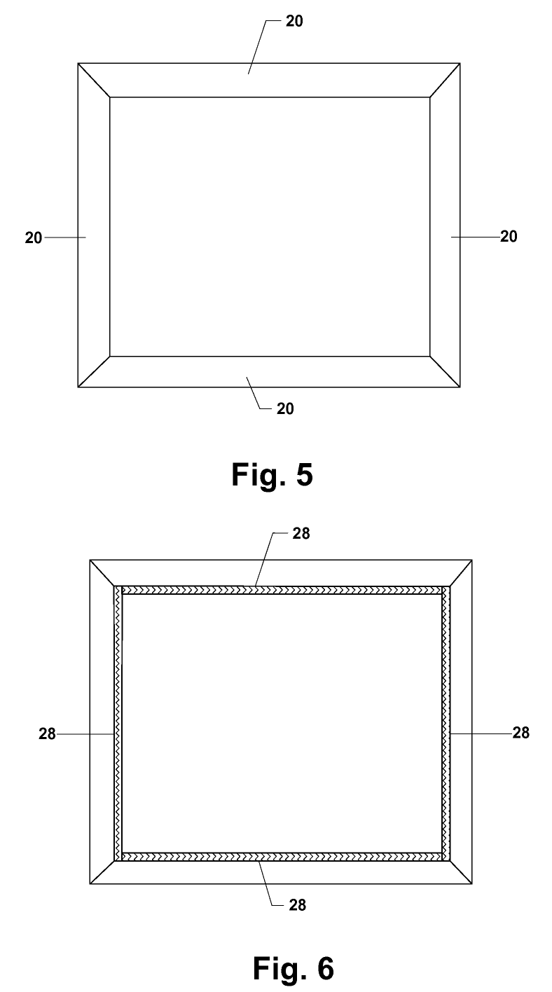

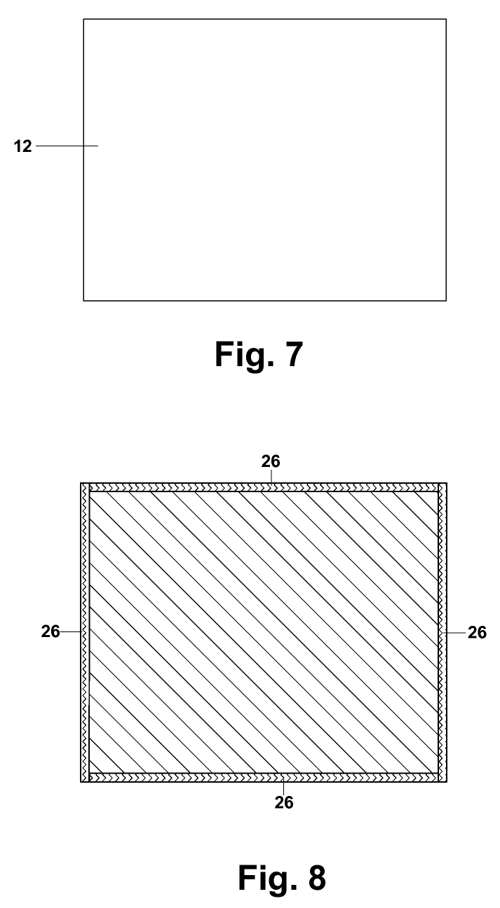

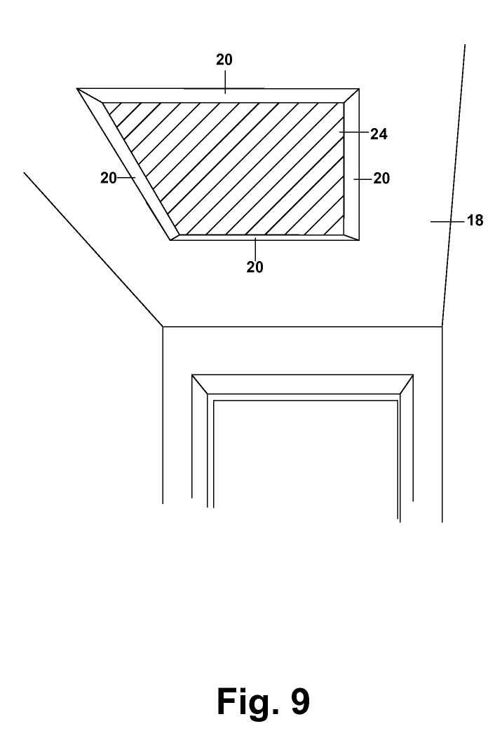

Referring to the drawings, particularly FIG. 1-9 an embodiment of the attic access insulated cover panel assembly 10 for insulating a scuttle hole panel is illustrated. In a typical embodiment, the insulated cover 10 has insulation 24 with a magnetic sealing system consisting of one side of the magnetic seal 26 is attached to the insulation panel 24 and the other side of the magnetic seal 28 is attached to the opening perimeter trim 20. The insulated cover 10 is permanently attached to the existing sheetrock or plywood panel 12 with mechanical fastening means that may include staples, caulking, or double sided tape.

In another embodiment of the invention, the insulation panel is composed of a semi rigid or rigid construction with multiple layers of insulation material 10 and the magnetic sealing system 11, which may or may not include matched pole magnetic strips. In lieu of matched pole magnetic strips, a combination of magnetic receptive material or metal may be employed. The magnetic sealing system 11 may be composed of one or a plurality of sides or may be manufactured in a variety of geometric shapes and compositions such as circles, rectangles, or squares. The magnetic sealing system may be composed of extruded, cast, or machined materials and may be flexible, semi rigid, and/or rigid. The magnetic sealing system component 26 is attached directly to the insulation panel 24 that may have a textured or smooth surface in a variety of colors to match the ceiling 18 colors and texture on one or both sides and may have a radiant barrier or mirror finish on one or both sides. The insulation panel 24 may be of varying thicknesses and materials to allow a high resistance to heat transfer. The existing sheetrock or plywood panel 12 may be disposed of and the insulated cover 10 used in place of the old panel. Other mechanical means for sealing the insulated panel 10 to the ceiling trim 20 shall not be limiting and other fastener means may be employed such as independent magnetic strips, magnetic fasteners, snaps, hook & loop, etc.

In other applications, for example the system may be used in an inverted form for example to insulate and seal a vent attached horizontally, vertically or at an angle.

The insulated cover with its magnetic attachment system is used to cover commercial and industrial fans when not in use and installed in various positions, shapes and configurations. The magnetic sealing system is designed to be adaptable and flexible enough to be applied as an insulated cover to practically any application.

For example:

Scuttle hole covers

Vent covers

Crawl space covers

Attic access openings

Roof hatch openings

Livestock ventilation fans

Exhaust fans

Air supply duct grills

Equipment service access panels

This is not an exhaustive list but presents some typical applications where this system can be applied to virtually eliminate air leakage and insulate an access opening.

I claim:

1. A cover assembly comprised of insulating material and a sealing system for insulating and sealing access openings and equipment openings.
an insulated cover that can be used in a vertical, horizontal, slanted, or inverted position to seal and insulate an access opening or equipment opening.
a cover manufactured of flexible, semi rigid or rigid insulation.
said cover can be any dimensions or geometric shape applicable to the particular application.
said cover can be sized to fit on site by cutting, sawing or other means to adapt the cover size and shape for a particular application.
a mechanical means to attach and/or seal a cover assembly to the access opening which may include magnetic, hook & loop, snaps or other common mechanical attachment means.
said mechanical means shall be adaptable to the opening size and shape and can be modified on site with common tools in the art.

2. A method to install an insulated cover to an existing access-opening panel.
cut the insulated cover to match the existing access panel dimensions
attach the insulated cover to the existing panel with a mechanical means to join the existing panel and insulated cover.
attach one side of the magnetic or other mechanical fastener system to the insulated cover by using the existing adhesive on the fastening system or the methods provided by the fastening system manufacturer.
position and attach mated side of the magnetic or other mechanical fastener system to the access opening trim for alignment with mated side of the fastening system attached to existing access panel by using the existing adhesive on the fastening system or the methods provided by the fastening system manufacturer.
